(19) United States
(12) Patent Application Publication
(10) Pub. No.: US 2026/0102781 A1
(43) Pub. Date: Apr. 16, 2026

(54) CENTRIFUGAL ATOMIZING PAINTING APPARATUS AND VEHICLE PAINTING ASSEMBLY USING THE SAME

(71) Applicants: Hyundai Motor Company, Seoul (KR); Kia Corporation, Seoul (KR)

(72) Inventor: Jae Hoon Jung, Hwaseong-si (KR)

(21) Appl. No.: 19/258,240

(22) Filed: Jul. 2, 2025

(30) Foreign Application Priority Data
Oct. 16, 2024 (KR) 10-2024-0141260

(51) Int. Cl. B05B 3/10; B05B 7/00

(52) U.S. Cl. CPC B05B 3/1014; B05B 7/0075

(57) ABSTRACT

A centrifugal atomizing painting apparatus is configured to eliminate factors that reduce transfer efficiency of paint toward a target object to increase the paint transfer efficiency. The centrifugal atomizing painting apparatus including a housing, a paint sprayer rotatably mounted within the housing and configured to atomize paint and to spray the atomized paint toward a target object while rotating, and an air discharger mounted within the housing and configured to discharge compressed air between the housing and the paint sprayer, wherein the compressed air has a rotational force in the opposite direction to the rotational direction of the paint sprayer.

### CROSS-REFERENCE TO RELATED APPLICATION

This application claims under 35 U.S.C. §119(a) the benefit of Korean Patent Application No. 10-2024-0141260, filed on Oct. 16, 2024, the entire contents of which are incorporated herein by reference.

### BACKGROUND

### TECHNICAL FIELD

The present disclosure relates to a centrifugal atomizing painting apparatus configured to be mounted on a painting robot for painting a vehicle, more particularly, to the centrifugal atomizing painting apparatus for eliminating factors that reduce transfer efficiency of paint toward a target object to increase the paint transfer efficiency.

### DESCRIPTION OF THE RELATED ART

Generally, a centrifugal atomizing painting apparatus is used to paint a vehicle body and one or more components of a vehicle. The painting apparatus may be mounted to a painting robot, and is configured to spray paint supplied through a paint supply line toward a target object.

As illustrated in FIGS. 10 and 11 (RELATED ART), a centrifugal atomizing painting apparatus of the related art comprises a housing 1 including a plurality of air spray holes 2 and a bell disc 3 mounted on an inner side of the rear end portion of the housing 1. The air spray holes 2 are formed at the rear end of the housing 1. The rear end portion of the bell disc 3 protrudes rearward of the air spray holes 2, and the bell disc 3 is positioned at a radial distance from the rear end of the housing 1 including the air spray holes 2.

The bell disc 3 is configured to rotate by a motor, and while rotating, paint is atomized and sprayed onto a target object. While paint is sprayed from the bell disc 3, the air spray holes 2 allow high-flow compressed air to be sprayed onto the target object. Here, the high-flow compressed air sprayed from the air spray holes 2 toward the target object is called “shaping air.”

However, when paint is discharged from the bell disc 3, the paint is discharged from the center of the bell disc 3 and receives the rotational force and centrifugal force of the bell disc 3, and the compressed air discharged from the air spray holes 2 is sprayed in a straight line toward the target object. Accordingly, a collision occurs between the paint sprayed from the bell disc 3 and the compressed air discharged from the air spray holes 2, and the paint may be over-sprayed due to the collision, resulting in a loss of some of the paint.

Moreover, because the paint moves at a high speed toward the target object by the compressed air discharged from the air spray holes 2 and hits the target object, some of the paint rebounds and may be lost in the process of the paint hitting the surface of the target object to form a coating film.

In order to reduce the loss of paint described above, in the related art, static electricity has been applied to the paint to reduce the overspray and rebound of the paint to thereby increase the efficiency of the paint transferred and attaching to the surface of the target object (i.e., the paint transfer efficiency).

However, even when static electricity is applied to the paint, there is a limit in increasing the paint transfer efficiency because paint losses occur due to the overspray and rebound of the paint.

Moreover, the painting apparatus and other equipment in a painting booth used for painting work may be contaminated due to over-sprayed and rebounding paint. Furthermore, in order to respond to the environmental pollution, additional costs may be incurred when using separate equipment to capture the over-sprayed and rebounding paint.

The above information disclosed in this Background section is only for enhancement of understanding of the background of the present disclosure, and therefore it may contain information that does not form the prior art that is already known to a person of ordinary skill in the art.

### SUMMARY

The present disclosure provides a centrifugal atomizing painting apparatus configured to eliminate factors that reduce transfer efficiency of paint toward a target object to increase the paint transfer efficiency.

The present disclosure is not limited to the foregoing, and other objects not mentioned herein will be clearly understood by those of ordinary skill in the art to which the present disclosure pertains based on the description below.

In one aspect, the present disclosure provides a centrifugal atomizing painting apparatus for painting a target object including a housing, a paint sprayer rotatably mounted within the housing and configured to atomize paint and to spray the atomized paint toward the target object while rotating, and an air discharger mounted within the housing and configured to discharge compressed air between the housing and the paint sprayer.

In a further aspect, the present disclosure provides the present disclosure provides a centrifugal atomizing painting apparatus including a housing, a paint sprayer rotatably mounted within the housing and configured to atomize paint and to spray the atomized paint toward a target object while rotating, and an air discharger mounted within the housing and configured to discharge compressed air between the housing and the paint sprayer, wherein the compressed air has a rotational force in the opposite direction to the rotational direction of the paint sprayer.

In an embodiment, the air discharger may include an air discharger body arranged within the housing, and a plurality of air passages extending while penetrating the air discharger body, arranged in the circumferential direction of the air discharger body, and configured to discharge the compressed air between the air discharger body and the housing.

In another embodiment, the plurality of air passages each may have a front passage portion and a rear passage portion. The rear passage portion may be bent at the rear end of the front passage portion to extend toward the rear end of the air discharger body, and may be inclined at a predetermined angle with respect to the axial direction of the air discharger body. Moreover, the rear passage portion may be inclined in the direction of a tangent line in contact with the outer circumferential surface of the air discharger body. Furthermore, the rear passage portion may extend to the rear end of the air discharger body.

In still another embodiment, the front passage portion may extend in the radial direction of the air discharger body. The front passage portion may extend to the outer circumferential surface of the air discharger body, and between the outer circumferential surface of the air discharger body and the inner circumferential surface of the housing, an air channel connected to the front end of the front passage portion may be provided. The air channel may include circumferential channels and axial channels, which are recessed into the outer circumferential surface of the air discharger body.

In yet another embodiment, a first air gap configured to pass there through compressed air discharged from the air discharger may be provided between the paint sprayer and the rear end of the housing.

In still yet another embodiment, a second air gap configured to pass there through compressed air discharged from the air passages may be provided between the air discharger body and the housing.

In a further embodiment, the rear portion of the air discharger body may include a body stepped portion, the inner circumferential surface of the housing may include a housing stepped portion protruding from the inner circumferential surface, and the second air gap may be provided between the front-end edge of the housing stepped portion and the rear-end edge of the body stepped portion.

In another further embodiment, the body stepped portion may be arranged on the radially inner side of the air discharger body relative to the rear ends of the air passages, and the inner circumferential surface of the housing stepped portion may be tapered rearwards. Moreover, the second air gap may have a size smaller than the rear end diameter of the air passage.

In still another further embodiment, the air discharger body may be positioned in front of the housing stepped portion.

In yet another further embodiment, the paint sprayer may have a rear edge portion protruding outward of the rear end of the housing. Furthermore, the paint sprayer may be connected to a static electricity generator configured to apply static electricity to the paint.

A vehicle painting assembly may include a painting robot; and the centrifugal atomizing painting apparatus mounted on the painting robot and configured to paint a vehicle.

Other aspects and embodiments of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given herein below by way of illustration only, and thus are not limitative of the present disclosure, and wherein:

FIG. 1 is a combined perspective view of a centrifugal atomizing painting apparatus according to an embodiment of the present disclosure;

FIG. 2 is an exploded perspective view of a centrifugal atomizing painting apparatus according to an embodiment of the present disclosure;

FIG. 3 is a schematic diagram of a centrifugal atomizing painting apparatus according to an embodiment of the present disclosure;

FIG. 4 is a perspective view of an air discharger of a centrifugal atomizing painting apparatus according to an embodiment of the present disclosure;

FIG. 5 is a side view of an air discharger according to an embodiment of the present disclosure;

FIG. 6 is a plan view of an air discharger according to an embodiment of the present disclosure;

FIG. 7 is an enlarged view of the section A in FIG. 3;

FIG. 8 is a view illustrating the path of air being discharged in a centrifugal atomizing painting apparatus according to an embodiment of the present disclosure;

FIG. 9 is a schematic view illustrating a painting process using a centrifugal atomizing painting apparatus according to an embodiment of the present disclosure; and

FIGS. 10 and 11 (RELATED ART) are views illustrating a centrifugal atomizing painting apparatus of the related art.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms "a", "an", and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described with reference to the accompanying drawings. The matters described in the attached drawings may be different from those actually implemented in order to facilitate description of the embodiments of the present disclosure.

In this specification, terms such as “front end,” “rear end,” “front,” “rear,” etc. indicating directions may be used in various ways, and unless otherwise specified, the terms are determined with respect to the flow direction of the compressed air used in the painting apparatus of the present disclosure.

Moreover, in this specification, the terms “first,” “second,” etc. may be used to describe various components, but the components are not limited to the terms. These terms are only used to distinguish one component from another. For example, a first component could be termed a second component, and similarly, a second component could be termed a first component, without departing from the scope of exemplary embodiments of the present disclosure.

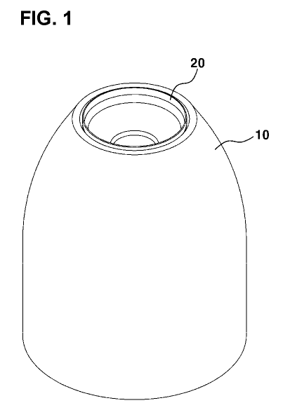

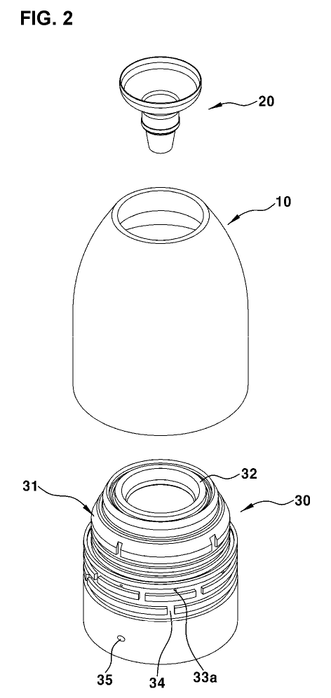

As illustrated in FIGS. 1-3, a centrifugal atomizing painting apparatus according to an embodiment of the present disclosure includes a housing 10, a paint sprayer 20, and an air discharger 30. The centrifugal atomizing painting apparatus is mounted on a painting robot and is configured to paint a vehicle.

The housing 10 is a hollow and cylindrical structure, and has a rear portion tapered in an axial direction. The rear portion of the housing 10 is tapered rearwards.

The paint sprayer 20 is configured to spray paint toward a target object, and is rotatably mounted within the housing 10. The paint sprayer 20 is connected to a motor 24 and is rotated by the operation of the motor 24. The paint sprayer 20 is supported by the motor 24 so as to be located inside a rear portion of the housing 10. Although not illustrated in the drawing, the motor 24 may be fixedly coupled to the housing 10 or to the air discharger 30. The paint sprayer 20 maintains a non-contact state, which means that the paint sprayer 20 is physically separated from the housing 10 and from the air discharger 30.

The paint sprayer 20 is configured to atomize paint and spray the same toward a target object while rotating by the motor 24. The paint sprayer 20 uses a centrifugal force generated during the rotation so as to atomize the liquid paint, and the paint particles atomized by the rotation of the paint sprayer 20 may arrive at and settle on the surface of the target object by the compressed air discharged from the air discharger 30. Although not illustrated in the drawing, a radially central portion of the paint sprayer 20 includes a discharge port (not shown) configured to discharge paint.

The paint sprayer 20 has a bell shape with a diameter increasing rearwards, and the rear end (i.e., a rear edge portion 22) of the paint sprayer 20 has a maximum diameter. Moreover, the paint sprayer 20 has the rear edge portion 22 positioned outward of the rear end of the housing 10. The rear edge portion 22 protrudes rearward of the housing 10. Because the rear edge portion 22 protrudes rearward of the housing 10, the external surface of the paint sprayer 20 may be prevented from being contaminated by the paint particles sprayed from the paint sprayer 20.

The paint sprayer 20 is commonly called a “bell disc” and has a structure of a general bell disc. Although not illustrated in the drawing, the bell disc may be supplied with paint through a paint supply line (not shown), and the amount of paint supplied to the paint supply line may be controlled by a regulator (not shown), etc. The structure of the bell disc is known, thus a detailed description therefor will be omitted.

The rear edge portion 22 has an outer diameter smaller than the inner diameter of the rear end of the housing 10, and there is a first air gap G1 between the rear edge portion 22 and the rear end of the housing 10. The first air gap G1 is adjacent to the rear edge portion 22 and extends in the circumferential direction of the rear edge portion 22. The first air gap G1 is formed uniformly in the circumferential direction of the rear edge portion 22.

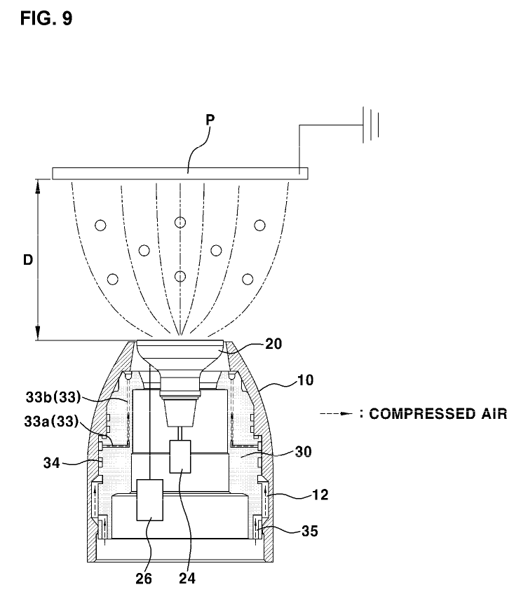

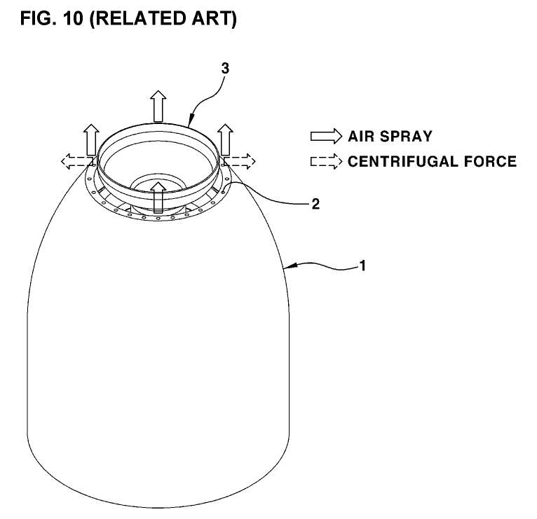

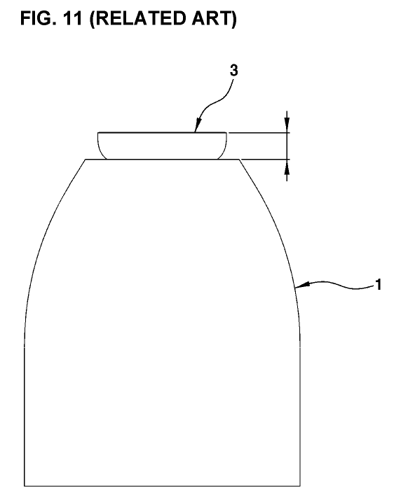

The first air gap G1 allows the compressed air discharged from the air discharger 30 to pass there through. The compressed air passing through the first air gap G1 is sprayed toward a target object (see “P” in FIG. 9) facing the paint sprayer 20.

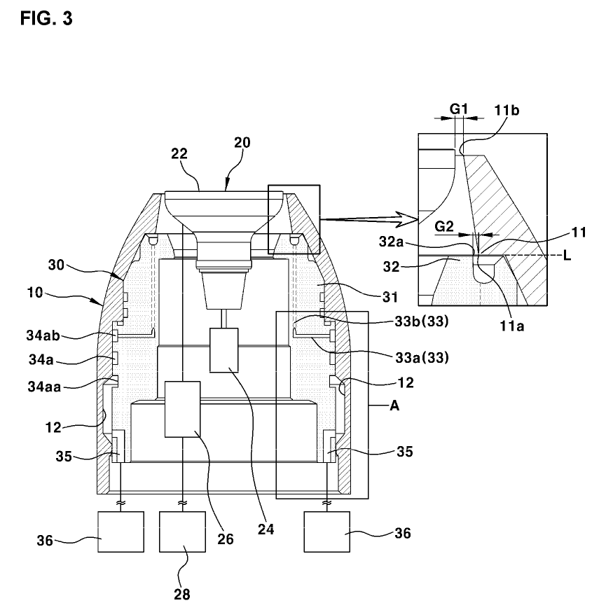

Referring to FIG. 3, the paint sprayer 20 is electrically connected to a static electricity generator 26. The static electricity generator 26 applies static electricity to paint particles sprayed from the paint sprayer 20 and is electrically connected to a voltage controller 28 configured to supply power. The static electricity generator 26 generates static electricity using power supplied and controlled by the voltage controller 28 and supplies the generated static electricity to the paint sprayer 20.

The centrifugal atomizing painting apparatus according to the present disclosure may include a controller (not shown) configured to control the operation of the motor 24. The controller may be a controller configured to perform overall control for the centrifugal atomizing painting apparatus.

The air discharger 30 is configured to discharge compressed air having a rotational force in the opposite direction to the rotational direction of the paint sprayer 20. As illustrated in FIGS. 3-6, the air discharger 30 includes an air discharger body 31 and a plurality of air passages 33 formed in the air discharger body 31. The air discharger body 31 is a hollow and cylindrical structure, and is mounted and fixed within the housing 10. The air discharger body 31 is placed within the housing 10 and does not protrude outward of the housing 10.

The air discharger 30 discharges compressed air through the first air gap G1 between the housing 10 and the paint sprayer 20, preventing backflow of the paint sprayed from the paint sprayer 20 and preventing the paint sprayer 20 from being contaminated by the backflow of the paint.

The air passages 33 are arranged in the circumferential direction of the air discharger body 31. In order to allow the compressed air discharged from the air passages 33 to pass through the first air gap G1 at a uniform intensity, the air passages 33 are arranged at equal intervals in the air discharger body 31. The compressed air passing through the first air gap G1 has a uniform flow rate and pressure regardless of the circumferential position of the first air gap G1.

Moreover, in order to allow the compressed air passing through the first air gap G1 to be sprayed in a circular pattern, at least eight air passages 33 are provided.

In order to apply the rotational force to the compressed air discharged from the air passages 33, each of the air passages 33 includes a rear passage portion 33b inclined at a predetermined angle α with respect to the axial direction of the air discharger body 31. Referring to FIGS. 3-5, each of the air passages 33 includes a front passage portion 33a and the rear passage portion 33b extending while penetrating the air discharger body 31.

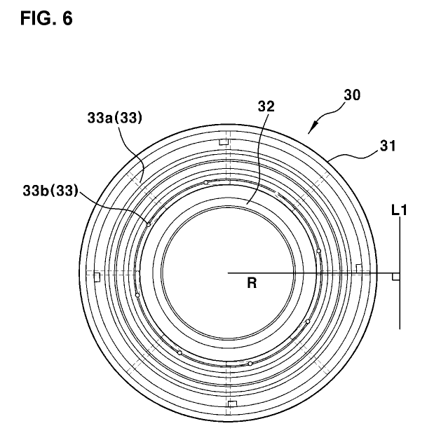

The front passage portion 33a extends in the radial direction of the air discharger body 31 (see “R” in FIG. 6), and the rear end of the front passage portion 33a is directly connected to the front end of the rear passage portion 33b such that air may flow there through. Moreover, the front end of the front passage portion 33a extends to the outer circumferential surface of the air discharger body 31 and is directly connected to an air channel 34 formed in the outer circumferential surface of the air discharger body 31.

The front end of the front passage portion 33a serves as an air inlet of the air passage 33, and the rear end of the rear passage portion 33b serves as an air outlet of the air passage 33. With respect to the flow direction of the compressed air, the front passage portion 33a is the upstream of the air passage 33, and the rear passage portion 33b is the downstream of the air passage 33.

The rear passage portion 33b is bent at the rear end of the front passage portion 33a and extends toward the rear end of the air discharger body 31. Here, the rear passage portion 33b is inclined at a predetermined angle α with respect to the axial direction of the air discharger body 31. Differently put, the rear passage portion 33b does not extend in the axial direction of the air discharger body 31 but is inclined at the predetermined angle α with respect to the axial direction of the air discharger body 31, and here, the rear passage portion 33b is inclined in the opposite direction to the direction of a tangent line (i.e., a tangential direction L1) in contact with the outer circumferential surface of the air discharger body 31 and to the rotational direction of the motor 24.

As illustrated in FIG. 6, the tangential direction L1 is an extending direction of the tangent line in contact with the outer circumferential surface of the air discharger body 31 with the front end of the front passage portion 33a as a reference point. Moreover, the rear passage portion 33b extends in a straight line, not in a curved line. Because the rear passage portion 33b is inclined at the predetermined angle α, the straightness of the compressed air discharged from the air passage 33 may be secured and maintained.

For example, the rear passage portion 33b may be inclined at about 10° with respect to the axial direction of the air discharger body 31. So as to discharge compressed air, the rear passage portion 33b extends to the rear end of the air discharger body 31 and penetrates the rear end of the air discharger body 31. All rear passage portions 33b of the air passages 33 are inclined in the same direction.

The air channel 34 is provided between the outer circumferential surface of the air discharger body 31 and the inner circumferential surface of the housing 10, and serves as a passage to deliver compressed air. The air channel 34 connects an air supply portion 36 to the air passages 33 such that air may flow there between, and serves to maintain the balance of the compressed air supplied from the air supply portion 36 to each of the air passages 33.

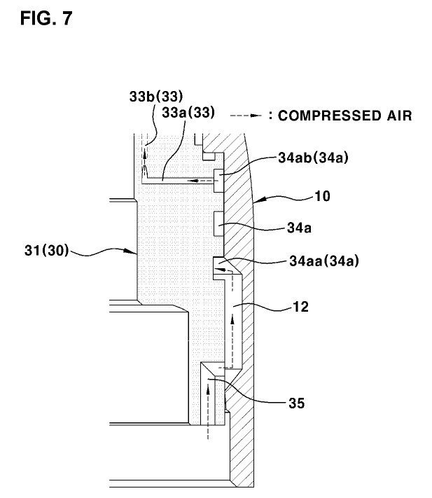

Referring to FIG. 3 and FIG. 7, a pair of air inlet ports 35 is formed at the front end of the air discharger body 31, and each of the air inlet ports 35 connects the air channel 34 to the air supply portion 36. The air inlet port 35 extends in a kind of inverted L shape from the front end of the air discharger body 31 to the outer circumferential surface of the air discharger body 31. So as to allow the compressed air introduced into the pair of air inlet ports 35 to be uniformly supplied to eight or more air passages 33, the air channel 34 extends in the circumferential and axial directions of the air discharger body 31.

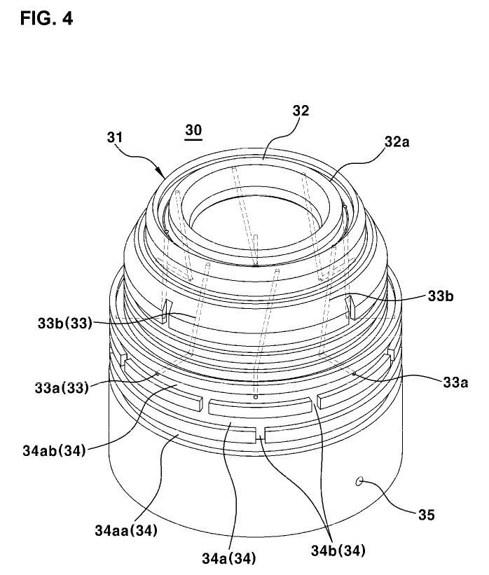

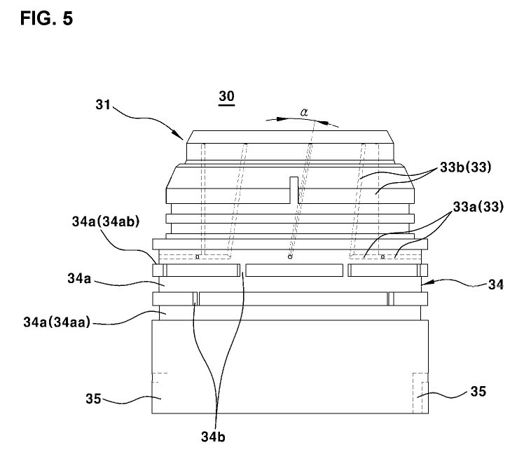

Referring to FIG. 4 and FIG. 5, the air channel 34 may include a plurality of circumferential channels 34a and axial channels 34b, which are recessed into the outer circumferential surface of the air discharger body 31. The circumferential channels 34a are spaced apart from one another in the axial direction of the air discharger body 31 and communicate with one another through the axial channels 34b. The axial channels 34b are spaced apart from one another in the circumferential direction of the air discharger body 31.

Among the circumferential channels 34a, a most downstream circumferential channel 34ab is directly connected to the front end of the front passage portion 33a, and a most upstream circumferential channel 34aa is connected to the air inlet port 35. The most upstream circumferential channel 34aa and the air inlet port 35 are connected through an inner channel 12 recessed into the inner circumferential surface of the housing 10.

With the air channel 34, the number of air inlet ports 35 connected to the air supply portion 36 may be reduced, and the balance of the compressed air supplied to the plurality of air passages 33 may be maintained. In more detail, because the compressed air supplied from the air supply portion 36 is not directly supplied to the air passage 33 but through the air channel 34, the flow rate and pressure of the compressed air supplied to the plurality of air passages 33 may be maintained uniformly.

Meanwhile, in order to prevent the flow rate and pressure of the compressed air discharged from the air passage 33 from being decreased, a second air gap G2 may be provided between the air discharger 30 and the housing 10.

Referring to FIG. 3, the rear portion of the air discharger body 31 includes a body stepped portion 32 protruding rearward toward the rear end of the housing 10. The body stepped portion 32 is arranged at a radially central portion of the air discharger body 31 and extends in the circumferential direction of the air discharger body 31. Here, the body stepped portion 32 is arranged radially inward than the rear end of the air passage 33 for air discharge (i.e., the rear end of the rear passage portion 33b). The body stepped portion 32 may be positioned close to the rear end of the air passage 33.

Moreover, the inner circumferential surface of the housing 10 includes a housing stepped portion 11 protruding inwards. The housing stepped portion 11 extends in the circumferential direction of the housing 10. The inner circumferential surface of the housing stepped portion 11 is separated from the outer circumferential surface of the paint sprayer 20 at a predetermined distance.

With respect to the radial direction of the housing 10 and air discharger body 31, a front-end edge 11a of the housing stepped portion 11 is positioned at a predetermined distance (i.e., the second air gap G2) from a rear-end edge 32a of the body stepped portion 32. Here, the front edge of the housing stepped portion 11 and the rear end of the body stepped portion 32 are arranged on a same horizontal line L. In other words, the front-end edge 11a of the housing stepped portion 11 and the rear-end edge 32a of the body stepped portion 32 are arranged on the same horizontal line L. The horizontal line L is a line extending in the radial direction of the housing 10 and air discharger body 31.

Here, the second air gap G2 has a size smaller than the rear end diameter of the air passage 33. The difference value between the second air gap G2 and the rear end diameter of the air passage 33 may be equal to or greater than a predetermined value. For example, the rear end diameter of the air passage 33 may be 2.5 mm, and the size of the second air gap G2 may be 0.52 mm. Due to the size difference between the rear end diameter of the air passage 33 and the second air gap G2, the flow rate and pressure of the compressed air discharged from the air passage 33 may be prevented from being reduced or lost, and also the internal negative pressure of the housing 10 may be induced.

Owing to the internal negative pressure of the housing 10, when the compressed air discharged from the air passage 33 is discharged to the first air gap G1, the air inside the housing 10 may also be discharged to the first air gap G1.

The front-end edge 11a of the housing stepped portion 11 may be rounded in order to reduce interference with the compressed air discharged from the air passage 33.

Moreover, in order to prevent the compressed air discharged from the air passage 33 from colliding with the housing stepped portion 11 and the paint sprayer 20 when the compressed air passes through the second air gap G2 and is discharged to the first air gap G1, the inner circumferential surface of the housing stepped portion 11 is tapered toward the rear end of the housing 10. More specifically, the overall inner circumferential surface of the housing stepped portion 11 is tapered from the front-end edge 11a of the housing stepped portion 11 to a rear-end edge 11b of the housing stepped portion 11. Accordingly, the compressed air discharged from the air passage 33 passes through the first air gap G1 without energy loss, which could be caused by colliding with the housing 10 and the paint sprayer 20.

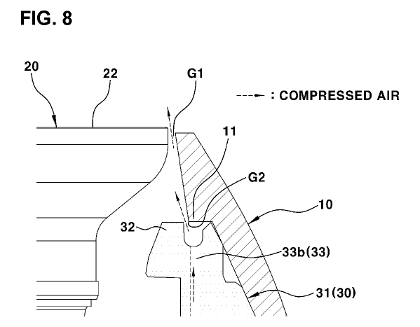

Furthermore, referring to FIG. 8, because the air discharger body 31 and the body stepped portion 32 are positioned in front of the housing stepped portion 11, the compressed air passing through the second air gap G2 passes through the space between the paint sprayer 20 and the housing stepped portion 11 and is discharged to the first air gap G1. Therefore, the paint sprayed from the paint sprayer 20 may be prevented from being introduced between the paint sprayer 20 and the housing 10 through the first air gap G1.

FIG. 9 schematically illustrates a painting process for coating the surface of a target object P using the centrifugal atomizing painting apparatus according to an embodiment of the present disclosure.

The target object P is a conductor made of metal and may increase the transfer efficiency of paint particles to which static electricity is applied. For example, the target object P may be a body or a component of a vehicle.

Referring to FIG. 9, the target object P is connected to ground to remove static electricity applied due to the paint particles sprayed from the paint sprayer 20.

The compressed air supplied to the air channel 34 passes through the air passage 33 and is discharged out of the air discharger 30. The compressed air discharged from the air passage 33 passes through, without colliding with the paint sprayer 20 and the housing 10, the second air gap G2 and the first air gap G1 and is discharged out of the housing 10.

Here, the compressed air moves straightly toward the target object P and at the same time rotates in the opposite direction to the rotational direction of the paint sprayer 20. Differently put, the compressed air discharged from the air passage 33 moves in a straight line toward the target object P while making a vortex motion. This is because the compressed air receives a rotational force in the opposite direction to the rotational direction of the paint sprayer 20 while passing through the rear passage portion 33b of the air passage 33.

The rotational force of the compressed air reduces the centrifugal force and rotational force applied to the paint particles discharged from the paint sprayer 20. Accordingly, the compressed air passing through the first air gap G1 moves in a straight line toward the target object P while reducing the centrifugal force and rotational force applied to the paint particles. Here, the paint particles do not disperse, but move toward the surface of the target object P together with the compressed air.

By reducing the centrifugal force and rotational force acting on the paint particles that are discharged from the paint sprayer 20, overspray of the paint may be suppressed and the straightness of the paint may be increased. Moreover, the loss of the paint due to the overspray of the paint may be reduced and the paint transfer efficiency to the target object P may be increased.

Furthermore, as the loss of paint due to the overspray of paint is reduced, the flow rate of compressed air may be reduced compared to the related art. Additionally, by using the compressed air at a flow rate lower than that of the related art, the rebound phenomenon caused by the impact of paint particles hitting the surface of the target object P is reduced, thereby also reducing the loss of paint due to the rebound of paint particles.

According to the present disclosure, rebound of the paint sprayed toward a target object P is drastically reduced by using compressed air at a flow rate lower than that of the related art, increasing the paint transfer efficiency. As such, factors that reduce the paint transfer efficiency for the target object (i.e., overspray and rebound of paint) are minimized, securing a paint transfer efficiency equivalent to or higher than that of the centrifugal atomizing painting apparatus of the related art while using the compressed air at a flow rate lower than that of the related art.

For example, compared to the related art where at least 300 Nℓ/min of compressed air was used, only 200 Nℓ/min of compressed air is used in the present disclosure, securing higher arrival efficiency than that of the related art and reducing the amount of paint and air usage.

Moreover, according to the present disclosure, the rebound phenomenon of paint may be minimized, reducing the distance between the paint sprayer 20 and the target object P (i.e., painting distance). By reducing the painting distance, the uniformity of the thickness of the coating film coated on the surface of the target object P is improved, and as a result, the painting performance and quality may be improved.

In the case where paint loss due to overspray and rebound is large as in the related art, there is a limit in reducing the painting distance D because the static electricity voltage applied to the paint increases. Whereas in the present disclosure, paint loss due to overspray and rebound is small, reducing the static electricity voltage and making it possible to perform proximity coating.

Meanwhile, when the painting distance is too small, sparks are easily generated due to the electric energy of the paint to which static electricity is applied. However, in the present disclosure, the straightness of the paint may be increased, delaying the phenomenon of the paint falling due to gravity, and securing the minimum painting distance for maintaining the painting quality.

Moreover, according to the present disclosure, compressed air from the air discharger 30 is discharged around the rear edge portion 22 of the paint sprayer 20, preventing a problem in which the paint sprayed from the paint sprayer 20 flows backwards to contaminate the paint sprayer 20.

Furthermore, according to the present disclosure, because the compressed air passing through the first air gap G1 is discharged at a uniform intensity regardless of the circumferential position of the paint sprayer 20, the flow of the compressed air may be analyzed. Accordingly, the optimal painting distance at which the straightness of the paint is not reduced by gravity may be predicted and calculated, and thus, the optimal painting distance to improve the painting quality while minimizing the rebound of the paint may be designed.

As is apparent from the above description, the present disclosure provides the following effects.

First, by providing a separate air discharger within the housing, the straightness of the paint may be realized with low-flow compressed air, and thus, compressed air at a lower flow rate compared to the related art may be used.

Second, by using low-flow compressed air, the rebound of the paint caused by the collision between the paint and the target object may be minimized, thereby reducing the amount of paint usage and increasing the paint transfer efficiency.

Third, by using low-flow compressed air, paint overspray may be suppressed, paint loss caused by the paint overspray happened in the related art may be prevented, the amount of paint and air usage may be reduced, and the paint transfer efficiency may be improved.

Fourth, by using low-flow air, the distance to the target object may be reduced, allowing for proximity coating, and the paint transfer efficiency may be improved owing to the proximity coating.

Fifth, though using low-flow compressed air, it is possible to secure the same level of painting performance as the related art where high-flow compressed air was used.

Effects of the present disclosure are not limited to what has been described above, and other effects not mentioned herein will be clearly recognized by those skilled in the art based on the above description.

Terms or words used in this specification and claims described below should not be construed as being limited to conventional or dictionary meanings. In addition, the scope of the present disclosure is not limited to the above-described embodiments, and various modifications and improvements by those skilled in the art using the basic concept of the present disclosure as defined in the claims below will also be included in the scope of the present disclosure.

What is claimed is:

1. A centrifugal atomizing painting apparatus for painting a target object, the apparatus comprising:
a housing;
a paint sprayer rotatably mounted within the housing and configured to atomize paint and to spray the atomized paint toward the target object based on rotating; and
an air discharger mounted within the housing and configured to discharge compressed air between the housing and the paint sprayer.

2. The apparatus of claim 1, wherein the compressed air has a rotational force in an opposite direction to a rotational direction of the paint sprayer.

3. The apparatus of claim 1, wherein the target object is a vehicle or a component of the vehicle.

4. The apparatus of claim 1, wherein the air discharger comprises:
an air discharger body placed within the housing; and
a plurality of air passages,
wherein the air passages are configured to extend while penetrating the air discharger body,
wherein the air passages are arranged in a circumferential direction of the air discharger body, and
wherein the air passages are configured to discharge the compressed air between the air discharger body and the housing.

5. The apparatus of claim 4, wherein the plurality of air passages each have a front passage portion and a rear passage portion, and
wherein the rear passage portion is bent at a rear end of the front passage portion to extend toward a rear end of the air discharger body, and is inclined at a predetermined angle with respect to an axial direction of the air discharger body.

6. The apparatus of claim 5, wherein the rear passage portion is inclined in a direction of a tangent line in contact with an outer circumferential surface of the air discharger body.

7. The apparatus of claim 5, wherein the rear passage portion extends to the rear end of the air discharger body.

8. The apparatus of claim 5, wherein the front passage portion extends in a radial direction of the air discharger body.

9. The apparatus of claim 8, wherein the front passage portion extends to an outer circumferential surface of the air discharger body, and between the outer circumferential surface of the air discharger body and an inner circumferential surface of the housing, an air channel connected to a front end of the front passage portion is provided.

10. The apparatus of claim 9, wherein the air channel comprises circumferential channels and axial channels, which are recessed into the outer circumferential surface of the air discharger body.

11. The apparatus of claim 1, wherein a first air gap is arranged between the paint sprayer and a rear end of the housing to allow passage of compressed air discharged from the air discharger.

12. The apparatus of claim 4, wherein a second air gap is arranged between the air discharger body and the housing to allow passage of compressed air discharged from the air passages.

13. The apparatus of claim 12, wherein:
the air discharger body has a rear portion including a body stepped portion,
the housing has an inner circumferential surface including a housing stepped portion protruding from the inner circumferential surface, and
the second air gap is provided between a front-end edge of the housing stepped portion and a rear-end edge of the body stepped portion.

14. The apparatus of claim 13, wherein the body stepped portion is arranged on a radially inner side of the air discharger relative to rear ends of the air passages.

15. The apparatus of claim 13, wherein an inner circumferential surface of the housing stepped portion is tapered rearwards.

16. The apparatus of claim 12, wherein the second air gap has a size smaller than a rear end diameter of the air passage.

17. The apparatus of claim 13, wherein the air discharger body is positioned in front of the housing stepped portion.

18. The apparatus of claim 1, wherein the paint sprayer has a rear edge portion protruding outward of a rear end of the housing.

19. The apparatus of claim 1, wherein the paint sprayer is connected to a static electricity generator configured to apply static electricity to the paint.

20. A vehicle painting assembly, comprising:
a painting robot; and
the centrifugal atomizing painting apparatus of claim 1 mounted on the painting robot and configured to paint a vehicle.
